(19) United States
(12) Patent Application Publication
(10) Pub. No.: US 2007/0030995 A1
(43) Pub. Date: Feb. 8, 2007

(54) Loudspeaker with natural hair leather diaphragm

(75) Inventors: J. Dwidjaja Setiabudi, Kudus (ID); Adisusanto, Kudus (ID); Setiawan Yusran, Kudus (ID); Hadi Prayitno, Kudus (ID); Anang Kartika, Kudus (ID); Bandi Sumardi, Kudus (ID)

Correspondence Address: ROTHWELL, FIGG, ERNST & MANBECK, P.C., 1425 K STREET, N.W., SUITE 800, WASHINGTON, DC, 20005, US

(73) Assignee: PT. Hartono Istana Teknologi, Kudus (ID)

(21) Appl. No.: 11/495,887

(22) Filed: Jul. 31, 2006

Related U.S. Application Data
(63) Continuation-in-part of application No. 10/911,534, filed on Aug. 5, 2004.

(51) Int. Cl. H04R 9/06

(52) U.S. Cl. 381/426

(57) ABSTRACT

A natural hair leather diaphragm for a loudspeaker. The acoustic impedance of the natural hair leather diaphragm is lower than several existing loudspeaker diaphragms and closer to the acoustic impedance of air. As a result, there is improved energy transfer from the loudspeaker to yield higher sound pressure level (SPL). The natural hair leather diaphragm is tough which prevents deformation caused by mechanical pressure and is thus not easily torn.

### CROSS-REFERENCE TO RELATED APPLICATION

This application is a continuation-in-part of U.S. patent application Ser. No. 10/911,534, filed Aug. 5, 2004.

### FIELD OF THE INVENTION

The present invention relates to the field of loudspeaker configurations.

### BACKGROUND OF THE INVENTION

Previous developments in material for use as a loudspeaker driver include materials such as magnetic material, voice coil material, frame material, diaphragm or cone material. Paper or carton material have been used for making the cone, as well as other materials such as polypropylene, honey comb, polyester fiber, glass fiber, aluminum, magnesium and titanium.

Alloy diaphragm materials like aluminum, magnesium and titanium are stiff and provide good heat conduction from the voice coil. However, the diaphragms are easily deformed by mechanical pressure and are difficult to reform.

It is well documented that leather is used for musical instrument diaphragms, such as large and small drums, tambourines etc. that produce good natural sound.

In electrical engineering it is known that the energy transfer from a source is maximized if the source impedance and load impedance are close in value or matched. Similarly in acoustics, diaphragm impedance which is closer to the impedance of air will result in greater energy transfer.

A loudspeaker cone body comprising leather material has been disclosed by Ono, in Japanese Patent No JP355147097. The skin leather diaphragm discussed is used as a supporting element of the honey-comb diaphragm. The core diaphragm material is honey-combed.

A thin leather for use in a telephone receiver diaphragm has been already described by DeForest, in U.S. Pat. No. 1,554,794. The DeForest diaphragm is exclusively used for telephone receiver applications. As is known, these diaphragm arrangements only provide a very narrow and limited frequency band-width, since one spring is used to maintain vibration of the conical diaphragm.

DeForest fails to disclose a leather material having a hair bearing surface for substantially matching the acoustic impedance of air.

Sun, in U.S. Pat. No. 5,680,093, describes a loudspeaker diaphragm using fibers perpendicularly fastened to one side of single layer cone or both sides of a double layer cone by an electrostatic fiber implanting apparatus to eliminate the interference of transverse waves. The fibers project essentially perpendicularly from the surface of the cone.

Takahashi, in Japanese Patent No. JP04367197A, provides leather as one material to make fibrillated polymethaphenylene-isophthalic amide binder and employs thermoplastic resin and thermosetting resin adhered to the diaphragm. The teachings indicate that since the diaphragm and cone comprise different material, second wave deflection occurs during vibration of the cone. This is, however, known in the art and has been discussed by Colloms, in High Performance Loudspeakers, 5^{th} edition.

### SUMMARY OF THE INVENTION

One object of the present invention is to provide an acoustically improved loudspeaker diaphragm with an improved impedance closer to air.

A further object of one embodiment of the present invention is to provide a loudspeaker diaphragm, comprising a diaphragm body and natural hair disposed over the surface of said body in parallel relation therewith, whereby the acoustic impedance of said body approximates the acoustic impedance of air.

Subsequent to taking measurements using a standard impedance tube, it was found that the leather diaphragm bearing the hair surface presented a lower acoustic impedance relative to conventional diaphragms. As such, the impedance, therefore, has a closer value to that of the impedance of air compared to other known diaphragms. This has ramifications in terms of improving the energy transfer which results in a higher sound pressure level.

A further object of one embodiment of the present invention is to provide a loudspeaker diaphragm comprising a diaphragm body composed of leather material and natural hair disposed over the surface of the body of leather material in parallel relation therewith, whereby the acoustic impedance of the body approximates the acoustic impedance of air.

The diaphragm can be formed by known techniques in the art. As a possibility, the existing loudspeaker cones can be improved by applying a layer of natural hair leather thereto with the remaining components of the loudspeaker driver remaining as known in the art.

Another object of one embodiment of the present invention is to provide a loudspeaker driver comprising a diaphragm body composed of leather material, a support frame, a voice coil, a plurality of magnets, and connection means for connecting the driver to a signal source.

Yet another object of one embodiment of the present invention is to provide a method to increasing the sound pressure level of a loudspeaker driver at a selected frequency, comprising providing a loudspeaker driver having a conical body comprised of leather with natural hair disposed in parallel relation therewith, having a conical body, the body comprising natural hair leather material, and passing a signal through the loudspeaker, whereby the signal is processed at a higher sound pressure level relative to having hair disposed in nonparallel relation.

### BRIEF DESCRIPTION OF THE DRAWINGS

Having thus generally described the invention, reference will now be made to the accompanying drawings.

FIG. 1 is a cross sectional view of one embodiment of the present invention;

FIG. 1A is an enlarged section of FIG. 1;

FIG. 2 is a cut away view of the present invention;

FIG. 3 is a cut away of yet another embodiment of the loudspeaker according to the present invention;

FIG. 4 is a schematic illustration of the apparatus used to measure the diaphragm acoustic impedance; and

FIG. 5 is a graphical representation of the frequency response curves comparing a hair leather diaphragm relative to a polypropylene diaphragm.

Similar numerals denote similar elements.

### DETAILED DESCRIPTION OF THE PREFERRED EMBODIMENTS

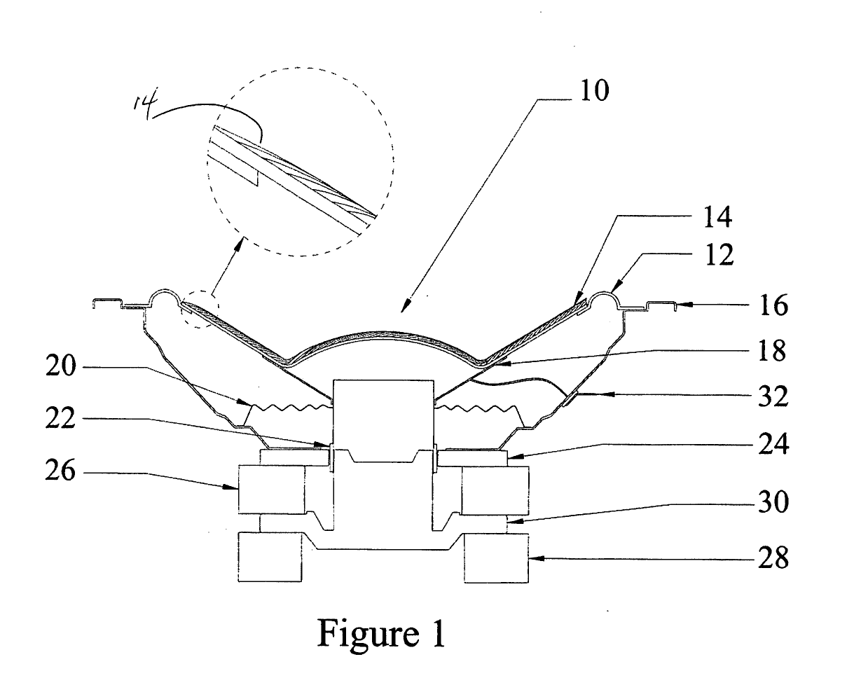

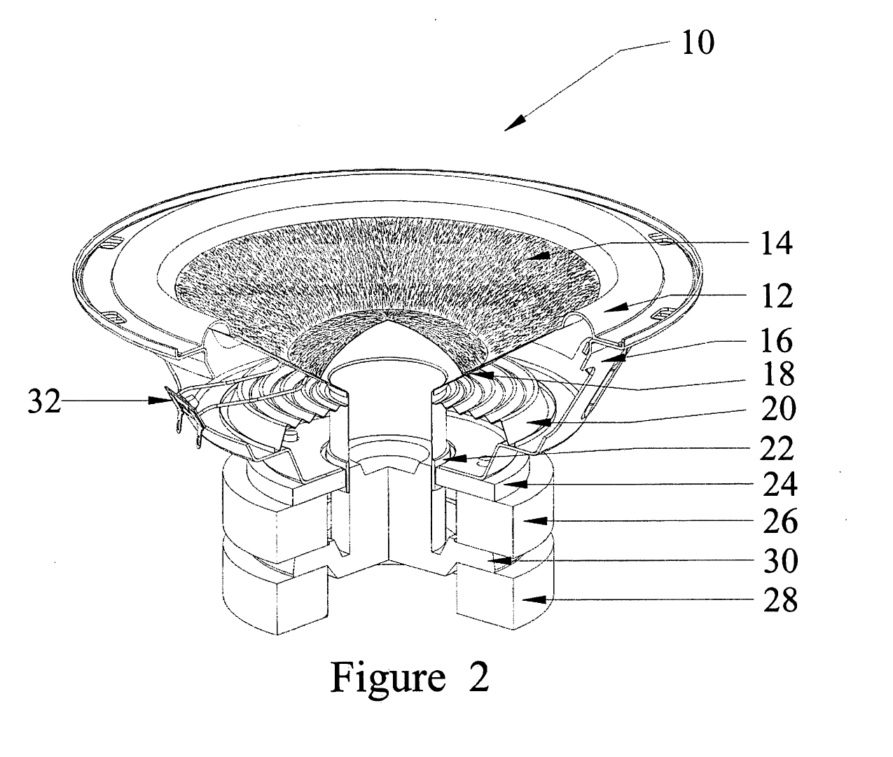

Referring now to FIG. 1, this is a cross sectional view of one embodiment of the present invention with FIG. 2 illustrating a cut away view. Numeral 10 denotes the overall loudspeaker driver which, as is known, includes an arcuate skirt 12 for permitting movement of the cone 14. The skirt 12 is typically formed of a suitable polymer or may comprise rubber or paper. These materials are well documented for use in loudspeaker manufacturing.

The diaphragm or cone 14 and skirt 12 are affixed to frame 16 having in general a frustoconical or basket type shape. The frame 16 also supports the paper cone 18, damper 20 and the voice coil 22. Adjacent the frame 16 is a washer 24 together with a first magnet 26 separated from a second magnet 28 by a yoke 30. Terminals 32 allow for connection of the driver 10 to a signal source (not shown). In this embodiment, the diaphragm or loudspeaker cone 14 is composed of natural hair leather material, which has good durability and results in the production of natural sound. The natural hair connected to the leather in the present case is slanted parallel to the leather diaphragm, shown best in FIG. 1A. The presence of the hair substantially improves the acoustic impedance. By selecting the appropriate thickness of hair and measuring with an impedance tube one can determine the optimum acoustic impedance to produce a higher sound pressure level.

The natural hair leather is extremely tough and for this reason it is therefore not easily deformed or torn with significant mechanical forces that typically occur when a loudspeaker driver is exposed to mishandling or a strong signal. As is known, the “woofing” action results in physical movement of the cone body which, over repeated use or sudden burst of low frequency sound, can result in diaphragm fracture of other structural compromise. By incorporating the hair leather material, this difficultly is obviated.

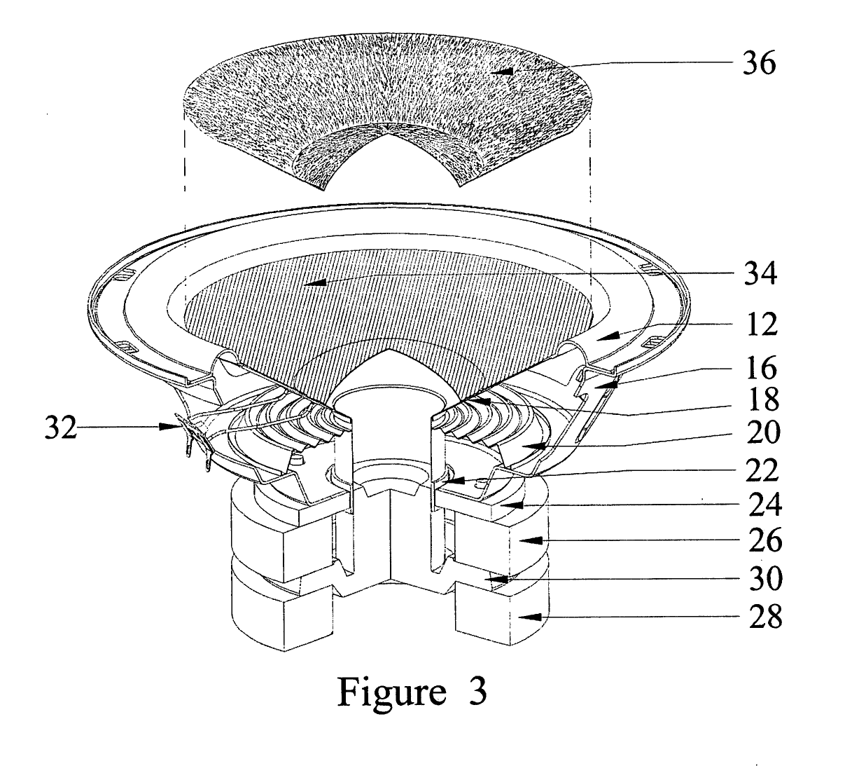

In respect of FIG. 3 shown as a further embodiment of the present invention in partially exploded and cut away form where the diaphragm 14 referenced from FIGS. 1 and 2 is denoted by numeral 34 and comprises a conventional polypropylene material to which optionally may be attached a layer of leather bearing hair as denoted by numeral 36. As will be appreciated, the material for diaphragm 34 could easily be paper, fiberglass polymeric material, composite material, or a suitable metal material known for use in diaphragm manufacturing.

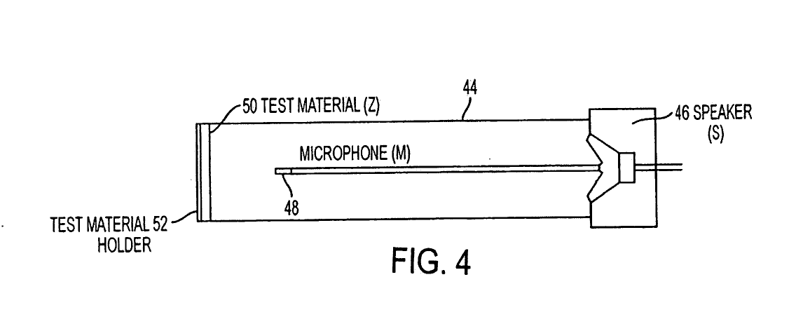

As is known by sound engineering personnel skilled in the art, every diaphragm material has an acoustic impedance value that can be measured using an impedance tube such as that shown in FIG. 4 and referenced by numeral 44. In use, a test signal is generated by the loudspeaker 46 with the sound waves (not shown) traveling down tube 44. A microphone 48 disposed within tube 44 measures the sound pressure along the tube 44. The diaphragm material to be measured is fitted at the end of the tube, the material being denoted by numeral 50 and held in place by a rigid holder 52. The acoustic impedance is known from the basic formula:

$$Z ( 0 ) = {Z}_{c} \{ \frac{2 ( p ) ( {p}^{2} - 1 ) sin 2 k ( {x}_{1} )}{( {p}^{2} + 1 ) + ( {p}^{2} - 1 ) cos 2 k ( {x}_{1} )} \}$$

$$with k = \frac{2 π f}{c}$$

Z_{c}=acoustic impedance of air
c=speed of sound of air
f=frequency

$$p = \frac{{p}_{max}}{{p}_{min}} = \frac{( 1 + r )}{( 1 - r )}$$
pₘₐₓ=maximum pressure
pₘᵢₙ=minimum pressure
r=reflection coefficient
x₁=first node location of the standing wave

Based on the formula and the tests conducted in accordance with the present invention, it was found that the acoustic impedance for the natural leather diaphragm having the hair was lower than the acoustic impedance of other loudspeaker diaphragm materials. Accordingly, the hair bearing diaphragm acoustic impedance was found to be closer to the acoustic impedance of air relative to other materials. This electro acoustic feature means that the diaphragm according to the present invention is capable of transferring acoustic energy from the diaphragm to the air better than the other materials tested which, in turn produces a higher sound pressure level. In terms of the thickness of the hair this can be adjusted to reach the optimum acoustic impedance.

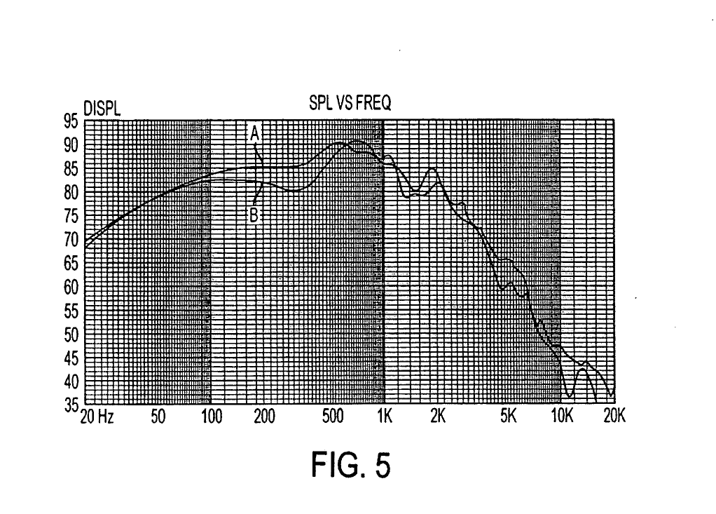

With reference to FIG. 5, there is illustrated graphically a series of frequency response curves that compare the sound pressure level of the natural hair leather diaphragm denoted by the data noted by A, with a diaphragm composed by polypropylene, the data being denoted by B. At a frequency between 100 Hz and 1200 Hz the sound pressure was found higher between 1 to 5 decibels (dB) for the natural hair leather diaphragm.

Although embodiments of the invention have been described above, it is not limited thereto and it will be apparent part of the present invention insofar as they do not depart from the spirit, nature and scope of the claimed and described invention.

We claim:

1. A loudspeaker diaphragm comprising:
a diaphragm body composed of leather material; and
natural hair disposed over the surface of said body of leather material in parallel relation therewith, whereby the acoustic impedance of said body approximates the acoustic impedance of air.

2. A loudspeaker diaphragm comprising:
a diaphragm body; and
natural hair disposed over the surface of said body in parallel relation therewith, whereby the acoustic impedance of said body approximates the acoustic impedance of air.

3. The loudspeaker diaphragm as set forth in claim 2, wherein said diaphragm further includes a member selected from the group consisting of paper, polymeric material, composite material, honeycomb, fiberglass, and metal, said member being attached to said diaphragm.

4. A loudspeaker driver comprising:
A diaphragm body composed of leather material; and natural hair disposed over the surface of said body of leather material in parallel relation therewith;
a support frame;
a voice coil;
a plurality of magnets; and
connection means for connecting said driver to a signal source.

5. A loudspeaker driver comprising:
a diaphragm body;
natural hair disposed over the surface of said body in parallel relation therewith;
a support frame;
a voice coil;
a plurality of magnets; and
connection means for connecting said driver to a signal source.

6. The loudspeaker driver as set forth in claim 5, wherein said diaphragm further includes a member selected from the group consisting of paper, polymeric material, composite material, honeycomb, fiberglass, and metal, said member being attached to said diaphragm.

7. A method to increasing the sound pressure level of a loudspeaker driver at a selected frequency, comprising:
providing a loudspeaker driver having a conical body comprised of leather with natural hair disposed in parallel relation therewith;
having a conical body, said body comprising natural hair leather material; and
passing a signal through said loudspeaker, whereby said signal is processed at a higher sound pressure level relative to having hair disposed in nonparallel relation.
